(19) United States
(12) Patent Application Publication
(10) Pub. No.: US 2006/0216462 A1
(43) Pub. Date: Sep. 28, 2006

(54) Nonwoven laminate

(75) Inventors: Leonardus Johannes Lucas, Duiven (NL); Marcellinus Cornelis Hendrikus Nieuwenhuizen, Duiven (NL)

Correspondence Address: OLIFF & BERRIDGE, PLC, P.O. BOX 19928, ALEXANDRIA, VA, 22320, US

(73) Assignee: COLBOND B.V., Arnhern (NL)

(21) Appl. No.: 11/385,671

(22) Filed: Mar. 22, 2006

(30) Foreign Application Priority Data
Mar. 22, 2005 (EP) 05006181.1

(51) Int. Cl. B32B 5/26; B32B 5/12; B32B 7/02

(52) U.S. Cl. 428/105; 442/364; 442/366; 442/381; 428/114; 428/107; 428/109; 428/110; 428/111; 428/113; 428/212; 156/157; 156/166

(57) ABSTRACT

A laminate is proposed that includes a plurality of layers of nonwoven material consisting of fibers or filaments. The layers are at least partially bonded to each other. The layers include at least one unidirectional layer consisting of one or more parallel bundle(s) of unidirectionally oriented and interconnected fibers or filaments, and at least one additional layer consisting essentially of a random-laid nonwoven material.

### BACKGROUND

This disclosure relates to a laminate comprising one or more layers of nonwoven material consisting of fibers or filaments, the layers being at least partially bonded to each other.

Laminates are known. They are defined as layered materials that are fabricated by gluing sheet materials, such as wood veneer, papers, cellulosic material, nonwovens composed of organic and inorganic fibers, glass plates, and the like, using hardenable plastics or thermoplastic materials under relatively low pressing pressure. Preferred binders include thermosetting condensation resins as well as reaction resins, glue films coated with artificial resins, or even simple thermoplastic films.

Laminates comprising materials in layers such as those listed above are suitable for a variety of applications, particularly those for which there is no preferred direction in terms of mechanical loading. When loads are present in specific directions, fabric webs are conventionally employed as one of the laminate layers.

However, the costs incurred in the production of fabric necessitated by the weaving process are higher than in the simple production of nonwovens.

### SUMMARY

A need, therefore, exists to obtain laminates composed of nonwoven layers that are, for example, more resistant in regard to loadability in certain preferred directions than are the known laminates, while at the same time being inexpensive and simple to fabricate.

Disclosed embodiments may meet this demand by providing a laminate comprising (1) at least one unidirectional (UD) layer consisting of one or more parallel bundle(s) of unidirectionally oriented and interconnected fibers or filaments, and (2) at least one additional layer consisting essentially of a random-laid nonwoven material.

The term “nonwoven” is defined as a textile fabric created by the loose juxtaposition and stacking of ordered or random fibers or filaments, which is able to hold together only to a limited extent intrinsically. It may consist of longitudinal fibers or filaments, longitudinal and cross fibers or filaments, or cross fibers or filaments. Alternatively, it may consist of fibers or filaments of a completely random orientation, the latter being differentiated by the term “random-laid” nonwoven material.

It should be understood that no differentiation is made between (staple) fibers and (continuous) filaments. In other words, when only one of the terms is used, the other is intended equally.

### DETAILED DESCRIPTION OF EMBODIMENTS

Unlike random-laid nonwoven materials, the unidirectional (UD) layer may contain a nonwoven material distinguished by the fact that its fibers or filaments are oriented in one direction. A layer of this type may be obtained, for example, by first laying and aligning filaments on ribbons parallel to each other, and optionally even drawn. Subsequently, these filaments may be coated with an adhesive or a thermoplastic polymer, for example, a hot-melt adhesive. After drying and heating, the UD layer may be wound onto rolls until ready for use.

This UD layer may then be brought into contact with a random-laid nonwoven material, and the two layers may then bonded to each other by another coating with appropriate adhesives or hot-melt adhesives.

The incorporation of the UD layer makes the laminate extremely resistant to mechanical load in directions parallel to the UD orientation.

It should be understood that it is possible, and often desirable, if the laminate has at least a second UD layer consisting of one or more parallel bundle(s) of unidirectionally oriented and interconnected fibers or filaments, this second UD layer may be oriented relative to the orientation of the first UD layer at an angle of between 0° and 90°, preferably 90°. When the two UD layers are oriented relative to each other at an angle of approximately 90°, this is called a cross-ply laminate.

For certain applications, it may be advantageous for the random-laid nonwoven material to be located as a sandwich between two UD layers, that is, for example, between a first and a second UD layer.

In general, the fibers or filaments that are present in at least one of the layers forming the laminate may comprise identical polymers, such as those, for example, consisting of polyethylene terephthalate, or may comprise different polymers, such as those, for example, consist of a mixture of polyethylene terephthalate and polybutylene terephthalate.

If different thermoplastic polymers are present, their melting points are preferably separated by at least 10° C., more preferably by at least 30° C., and more preferably by at least 50° C. The bonding of the layers to each other, and/or one below the other, should be effected by surface-fusing or melting, followed by cooling of the lower-melting-point thermoplastic polymer.

These laminates have the advantage that for purposes of their fabrication the more expensive coating process can be avoided or minimized. If, for example, the UD layer and/or the random-laid nonwoven material consist of a mixture of filaments of thermoplastic polymers with different high melting points, then simple heating may be sufficient to bond them. The fraction of lower-melting-point filaments does not need to be very high for this purpose.

In exemplary embodiments, the layers of the laminate may contain fibers or filaments consisting of the same thermoplastic polymers, wherein their structure consists of two or more polymer components with melting points differing by at least 10° C., preferably at least 30° C., and more preferably at least 50° C. The bonding of the layers to each other, and/or one below the other, is effected by surface-fusing or melting, followed by cooling of the lower-melting-point thermoplastic component.

It may, therefore, be preferable to use thermoplastic polymers that have a bicomponent structure. It may be preferable to use those with a core-sheath structure, where the sheath component has the lower melting point.

It should be understood that combinations of thermoplastic polymers having differing melting points, and those having the described bicomponent structure are also possible.

Achievement of the objectives according to the invention may be effectively met by ensuring that all layers forming the laminate consist of the same fibers or filaments, and consequently differ only in their respective orientation pattern, that is, as a random-laid nonwoven material or as a UD layer.

Further, attempting to ensure that during fabrication all layers forming the laminate have a core-sheath bicomponent structure, then it is possible to have a single starting material while simultaneously achieving excellent stability for the laminate obtained, and to achieve the bonding of the individual layers one below the other, and to each other, both simply and without intermediate coating steps.

Selection of the polymer components forming the core-sheath bicomponent structure does not need to meet any special requirements.

Especially well-suited for the layers forming the laminate are those filaments which have bicomponent structures in the form of a core-sheath structure in which the core component consists essentially of polyethylene terephthalate (PET), while the sheath component consists essentially of polyamide, in particular, polyamide 6.

Improved results can also be achieved if in addition to using PET as the core component, a polyolefin, in particular, polypropylene, is used as the sheath component.

Also suitable for the bicomponent structure is a core-sheath structure in which the core component consists of polyethylene terephthalate, and the sheath component consists of a polybutylene terephthalate or a polyether ester. An excellent polyether ester suitable for this purpose is a copolymer consisting of a polybutylene terephthalate and polytetrahydrofuran. A polyether ester of this type may have a melting point of between 190° and 200° C.

The ratio of core component to sheath component in the bicomponent structures may range between 95/5 and 5/95 vol/vol, for example, 70/30 vol/vol.

The titer of the bicomponent filaments to be used may range preferably between 500 and 2000 dtex.

The weights of the nonwovens range between 10 and 500 g/m².

What is claimed is:

1. A laminate, comprising a plurality of layers of nonwoven material consisting of fibers or filaments, wherein these layers are at least partially bonded to each other, the plurality of layers comprising:
at least one unidirectional layer consisting of one or more parallel bundle(s) of unidirectionally oriented and interconnected fibers or filaments; and
at least one layer consisting essentially of a random-laid nonwoven material,
wherein all layers forming the laminate consist of fibers or filaments that have bicomponent structures in the form of a core-sheath structure.

2. The laminate of claim 1, wherein the laminate further comprises at least a second unidirectional layer, each unidirectional layer consisting of one or more parallel bundle(s) of unidirectionally oriented and interconnected fibers or filaments,
wherein the second unidirectional layer has an orientation relative to the orientation of a first unidirectional layer at an angle between 0° and 90°.

3. The laminate of claim 2, wherein the random-laid nonwoven material is located between the first and second unidirectional layers.

4. The laminate of claim 1, wherein a core component of the core-sheath structure consists essentially of polyethylene terephthalate, while a sheath component consists essentially of polyamide 6.

5. The laminate of claim 1, wherein a core component of the core-sheath structure consists essentially of polyethylene terephthalate, while a sheath component consists essentially of at least one of polybutylene terephthalate or a polyether ester.

6. The laminate of claim 5, wherein when the sheath component consists essentially of a polyether ester, the polyether ester comprises a copolymer consisting essentially of polybutylene terephthalate and polytetrahydrofuran.

7. The laminate of claim 1, wherein a ratio of a core component of the core-sheath structure to a sheath component of the core-sheath structure is in a range of 95/5 to 5/95 by volume.

8. The laminate of claim 1, wherein a sheath component of the core-sheath structure has a lower melting point than a core component of the core-sheath structure, and the melting points differ by at least 10° C.

9. The laminate of claim 8, wherein the melting points differ by at least 30° C.

10. The laminate of claim 8, wherein the melting points differ by at least 50° C.

11. The laminate of claim 2, wherein the angle of the orientation between the second unidirectional layer and the first unidirectional layer is about 90°.

12. A method for making a laminate comprising a plurality of layers of nonwoven material consisting of fibers or filaments wherein the layers are at least partially bonded to each other, the method comprising:
preparing for bonding at least one unidirectional layer consisting of one or more parallel bundle(s) of unidirectionally oriented and interconnected fibers or filaments; and
preparing for bonding at least one layer consisting essentially of a random-laid nonwoven material,
wherein all layers forming the laminate consist of fibers or filaments that have bicomponent structures in the form of a core-sheath structure.

13. The method of claim 12, wherein preparing for bonding the at least one unidirectional layer further comprises:
laying and aligning filaments on ribbons parallel to each other; and
coating the filaments with at least one of an adhesive or a thermoplastic polymer.

14. The method of claim 12, further comprising bonding the layers to each other with at least one of an adhesive or a hot-melt adhesive.

15. The method of claim 12, further comprising preparing for bonding at least a second unidirectional layer, each unidirectional layer consisting of one or more parallel bundle(s) of unidirectionally oriented and interconnected fibers or filaments, wherein the second unidirectional layer has an orientation relative to the orientation of a first unidirectional layer at an angle between 0 and 90°.

16. The method of claim 15, wherein the random-laid nonwoven material is bonded between the first and the second unidirectional layers.

17. The method of claim 15, wherein the angle of the orientation between the second unidirectional layer and the first unidirectional layer is about 90°.

18. The method of claim 12, wherein a sheath component of the core-sheath structure has a lower melting point than a core component of the core-sheath structure, and the melting points differ by at least 10° C.

19. The method of claim 18, wherein the melting points differ by at least 30° C.

20. The method of claim 18, wherein the melting points differ by at least 50° C.
